(19) United States
(12) Patent Application Publication
(10) Pub. No.: US 2002/0052747 A1
(43) Pub. Date: May 2, 2002

(54) Method and system of interpreting and presenting web content using a voice browser

(76) Inventor: Ramesh R. Sarukkai, Union City, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/933,956

(22) Filed: Aug. 21, 2001

Related U.S. Application Data
(60) Provisional application No. 60/226,611, filed on Aug. 21, 2000.

(51) Int. Cl. G10L 21/00; G10L 11/00

(52) U.S. Cl. 704/270

(57) ABSTRACT

A highly distributed, scalable, and efficient voice browser system provides the ability to seamlessly integrate a variety of audio into the system in a unified manner. The audio rendered to the user comes from various sources, such as, for example, audio advertisements recorded by sponsors, audio data collected by broadcast groups, and text to speech generated audio. In an embodiment, voice browser architecture integrates a variety of components including: various telephony platforms (e.g. PSTN, VOIP), scalable architecture, rapid context switching, and backend web content integration and provides access to information audibly.

### CLAIM OF PRIORITY

This application claims priority from U.S. provisional patent Application No. 60/226,611, entitled “METHOD OF INTERPRETING AND PRESENTING WEB CONTENT USING A VOICE BROWSER,” filed Aug. 21, 2000, incorporated herein by reference.

### FIELD OF THE INVENTION

The present invention, roughly described, pertains to the field of the fetching of voice mark up documents from web servers, and interpreting the content of these documents in order to render the information on various devices with an auditory component such as a telephone.

### BACKGROUND

The enormous success of the Internet has fueled a variety of mechanisms of access to Internet content anywhere, anytime. A classic example of such a philosophy is the implementation of Yahoo! content access to the Web through wireless devices, such as phones. Recently the notion of accessing web content through devices such as telephones has increased interest in the notion of “voice portals”. The idea behind voice portals is to allow access to the enormous Web content through not only the visual modality but also through the audio modality (from devices including but not limited to telephones).

Various forums and standard committees have been working to define a standard voice markup language to present content through devices such as a telephone. Examples of voice markup languages include VoxML, VoiceXML, etc. The majority of these languages conform to the syntactic rules of W3C eXtensible Markup Language (XML). Additionally, companies such as Motorola and IBM have Java versions of voice browsers available, such as Motorola's VoxML browser.

In order to accommodate the rapid growth of the number of registered users in a system which already serves millions of registered users (such as Yahoo!), a need exists for a highly distributed, scalable, and efficient voice browser system. Furthermore, the ability to seamlessly integrate a variety of audio into the system in a unified manner is needed. The audio rendered to a user often comes from various sources, such as, for example, audio advertisements recorded by sponsors, audio data collected by broadcast groups, and text to speech generated audio.

Furthermore, many conventional systems do not allow access to content, and therefore it is difficult to markup a wide variety of content in a voice markup language for conventional systems. In a portal such as Yahoo!, which has direct access to backend servers, a need exists for efficiently generating Voice XML documents from the backend servers that can provide general and personalized Web content. Additionally, a need exists for handling the variety of content offered by a large portal, such as Yahoo!.

### SUMMARY

The present invention, roughly described, includes the implementation of a voice browser: a browser that allows users to access web content using audio or multi-modal technology. The present invention was developed to allow universal access to voice portals through alternate devices including the standard telephone, cellular telephone, personal digital assistant, etc. Backend servers provide information in the form of a Voice Markup Language which is then interpreted by the voice browser and rendered in multimedia form to the user on his/her device.

Alternative embodiments include multi-modal access through alternate devices such as wireless devices, palms, and any other device capable of multi-media (including speech) input or output capabilities.

An advantage of the voice browser architecture according to an embodiment of the present invention, is the ability to seamlessly integrate a variety of components including: various telephony platforms (e.g. PSTN, VOIP), scalable architecture, rapid context switching, and backend web content integration.

An embodiment of the voice browser includes a reentrant interpreter which allows the maintenance of separate contexts of documents that the user has chosen to visit, and a document caching mechanism which stores visited markup documents in an intermediary compiled form.

According to another aspect of the present invention, the matching of textual strings to prerecorded prompts by using typed prompt classes is provided.

A method executed by the voice browser includes use of a reentrant interpreter. In an embodiment, a user's request for a page is processed by the voice browser by checking to see if it is cacheable and is in a Voice Browser cache. If not found in the cache, then an HTTP request is made to a backend server. The backend server feeds the content into a template document, such as a yvxml document, which describes how properties should be presented. The voice browser first parses the page and then converts it into an intermediary form for efficiency reasons.

The intermediary form, according to an aspect of the present invention, is produced by encoding each XML tag into an appropriate ID, encoding the Tag state, extracting the PCDATA and attributes for each tag, and storing an overall depth-first traversal of the parse tree in the form of a linear array. The stored intermediate form can be viewed as a pseudo-assembly code which can be efficiently processed by the voice browser/interpreter in order to “execute” the content of the page.

In the case that the content is cacheable content, this intermediary form is cached. Thus, the next time the page is retrieved, interpretation can be started by switching the interpreter context to the cached page and setting the “program counter” to point to the first opcode of the processed yvxml document. The interpreter can reach a state in which the context is to be switched, at which point a new URI (or a form submission with appropriate fields) is created.

These and other features, aspects, and advantages of the present invention are apparent from the Drawings which are described in narrative form in the Detailed Description of the Invention.

### BRIEF DESCRIPTION OF THE DRAWINGS

The invention will be described with respect to the particular embodiments thereof. Other objects, features, and advantages of the invention will become apparent with reference to the specification and drawings in which:

FIG. 1 is a block diagram illustrating the various components of a voice access to web content architecture according to an embodiment of the present invention;

FIG. 2 is a flow chart illustrating a method by which the voice browser processes a document request from an Internet user, according to an embodiment of the present invention;

FIG. 3 is a flow chart illustrating a method by which the voice browser generates an intermediary form of a document suitable for execution and caching by the voice browser, according to an embodiment of the present invention;

FIG. 4 is a block diagram illustrating the various logical components of the voice browser, according to an embodiment of the present invention;

FIG. 5 illustrates a method performed by the parser, compiled document source object, and the reentrant interpreter of the voice browser on a web page, according to an embodiment of the present invention;

FIG. 6 illustrates a method of processing an entry of the linear array of instructions which constitutes the intermediary form of the web page performed by the reentrant interpreter of the voice browser, according to an embodiment of the present invention;

FIG. 7 illustrates a method of processing a context switch occurring during the processing of the intermediary form of the web page performed by the reentrant interpreter of the voice browser, according to an embodiment of the present invention;

FIG. 8 illustrates a method performed by the parser, compiled document source object, and reentrant interpreter of the voice browser upon the occurrence of a cache miss during the processing of context switch that is not within the document, according to an embodiment of the present invention;

FIG. 9 illustrates the prompt mapping configuration and audio prompt database used by the dynamic typed text to prompt mapping mechanism, according to an embodiment of the present invention;

FIG. 10 illustrates the difference in the content provided to the voice browser with the dynamic typed text to prompt mapping mechanism, and without the dynamic typed text to prompt mapping mechanism, according to an embodiment of the present invention; and,

FIG. 11 illustrates a general purpose computer architecture suitable for executing the system and methods according to various embodiment of the present invention which are performed by the various components of the voice access to web content system according to the present invention.

In the Figures, like elements are referred to with like reference numerals. The Figures are more thoroughly described in narrative form in the Detailed Description of the Invention.

### DETAILED DESCRIPTION

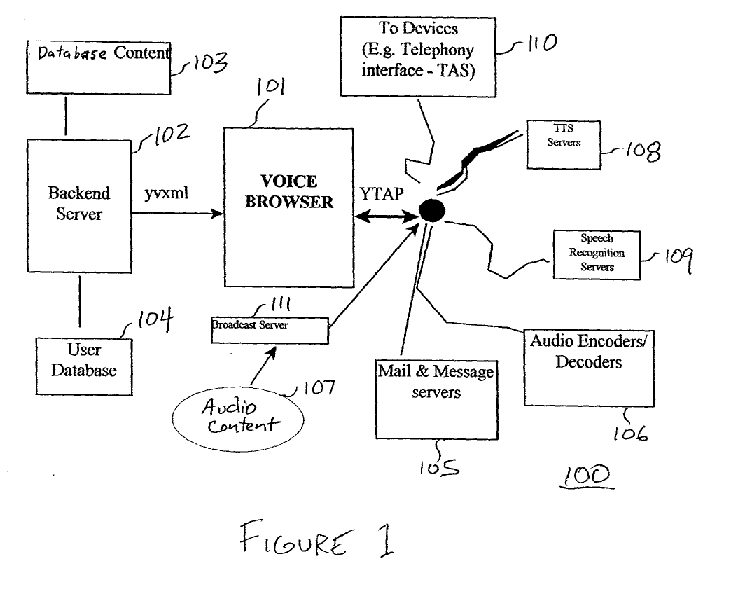

FIG. 1 is a block diagram illustrating examples of various components of voice access to web content architecture 100, according to an embodiment of the present invention.

Voice browser 101 may be configured to integrate with any type of web content architecture component, such as backend server 102, content database 103, user databases/authentication 104, e-mail and message server 105, audio encoders/decoders 106, audio content 107, speech synthesis servers 108, speech recognition servers 109, telephony integration servers 110, broadcast server 111, etc. Voice browser 101 provides a user with access through a voice portal to content and information available on the Internet in an audio or multi-modal format. Information may be accessed through voice browser 101 by any type of electronic communication device, such as a standard telephone, cellular telephone, personal digital assistant, etc.

A session is initiated with voice browser 101 through a voice portal using any of the above described devices. In an embodiment, once a session is established a unique identification is established for that session. The session may be directed to a specific starting point by, for example, a user dialing a specific telephone number, based on user information, or based on the particular device accessing the system. After the session has been established a “document request” is delivered to voice browser 101. As described herein a document request is a generalized reference to a user's request for a specific application, piece or information (such as news, sports, movie times, etc.) or for a specific callflow. A callflow may be initiated explicitly or implicitly. This may be either by default or by a user speaking keywords, or entering a particular keystroke.

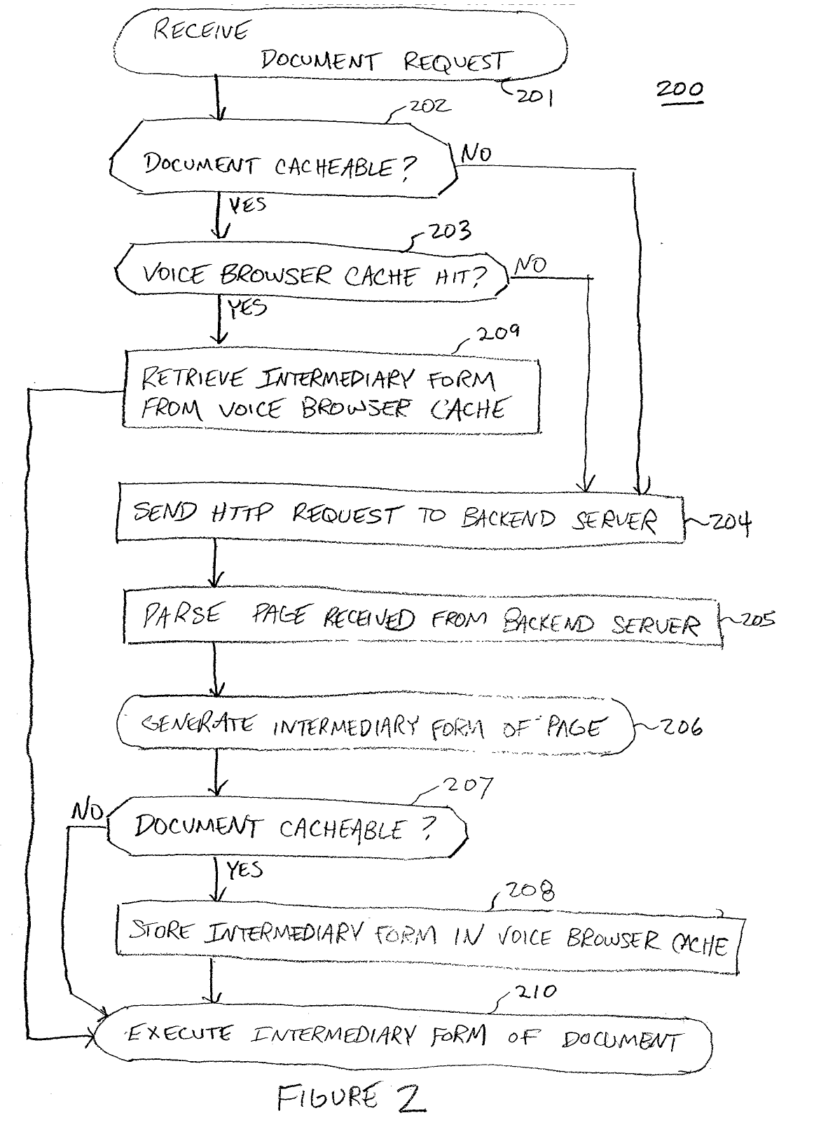

FIG. 2 illustrates a flow chart outlining a method 200 by which voice browser 101 processes a document request from a user, according to an embodiment of the present invention. As one who is skilled in the art would appreciate, FIGS. 2, 3, 5, 6, 7, and 8 illustrate logic boxes for performing specific functions. In alternative embodiments, more or fewer logic boxes may be used. In an embodiment of the present invention, a logic box may represent a software program, a software object, a software function, a software subroutine, a software method, a software instance, a code fragment, a hardware operation or user operation, singly or in combination.

In logic box 201 voice browser 101 receives a document request from a user. Upon receipt of a document request in logic box 202 it is determined whether the requested document is cacheable. If it is determined that the document is cacheable, control is passed to logic box 203. If however, it is determined in logic box 202 that the document is not cacheable, control is passed to logic box 204 and the process continues.

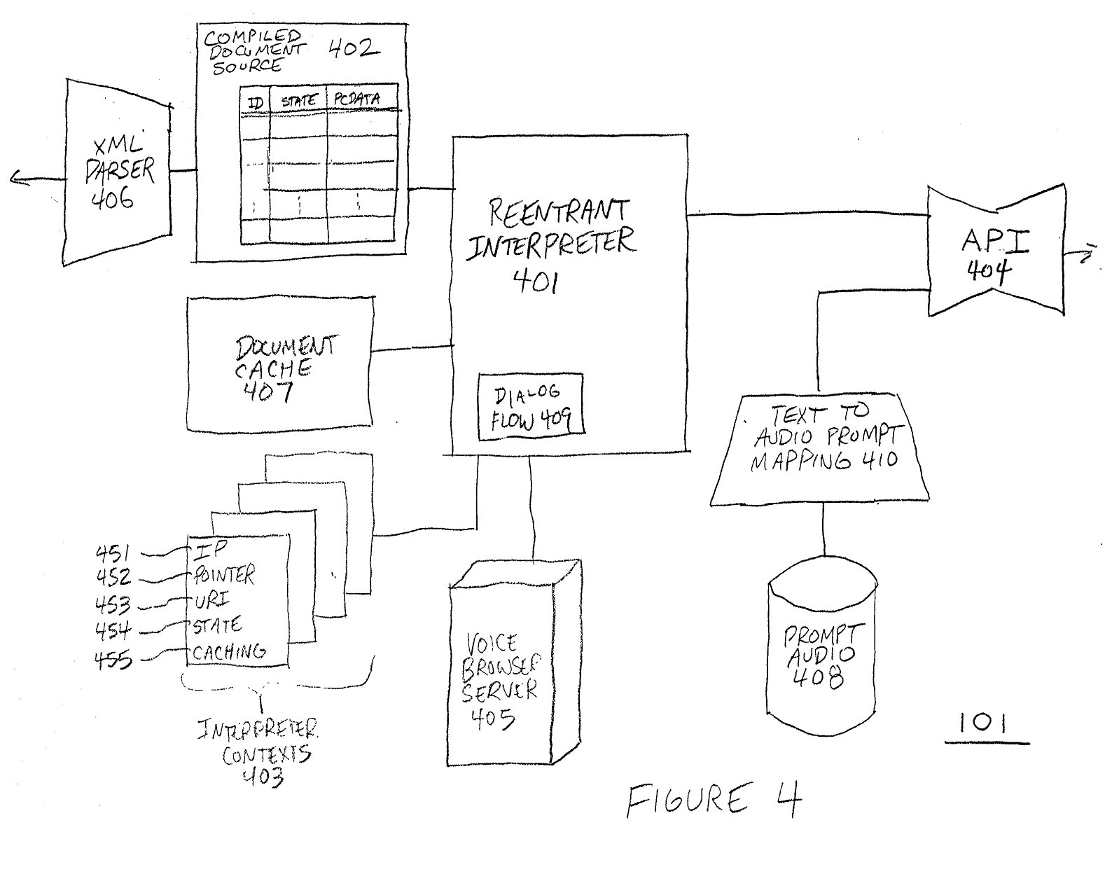

In logic box 203 it is determined whether the requested document is already located in voice browser cache 407 (FIG. 4). If it is determined in logic box 203 that the document is currently located in voice browser cache 407, control is passed to logic box 209. Otherwise control is passed to logic box 204.

In logic box 204 voice browser 101 sends a “Request,” such as an HTTP request to backend server 102. It will be understood that a Request may be formatted using protocols other than HTTP. For example, a Request may be formatted using Remote Method Invocation (RMI), generic sockets (TCP/IP), or any other type of protocol.

Upon receipt of a Request, backend server 102 prepares a “Response,” such as an HTTP Response, containing the requested information. In an embodiment, the Response may be in a format similar to the Request or may be generated according to a XML template, such as a yvxml template, including tags and attributes, which describes how the properties of the response should be presented. In an example, templates, such as a yvxml template, separate presentation information of a document from document content.

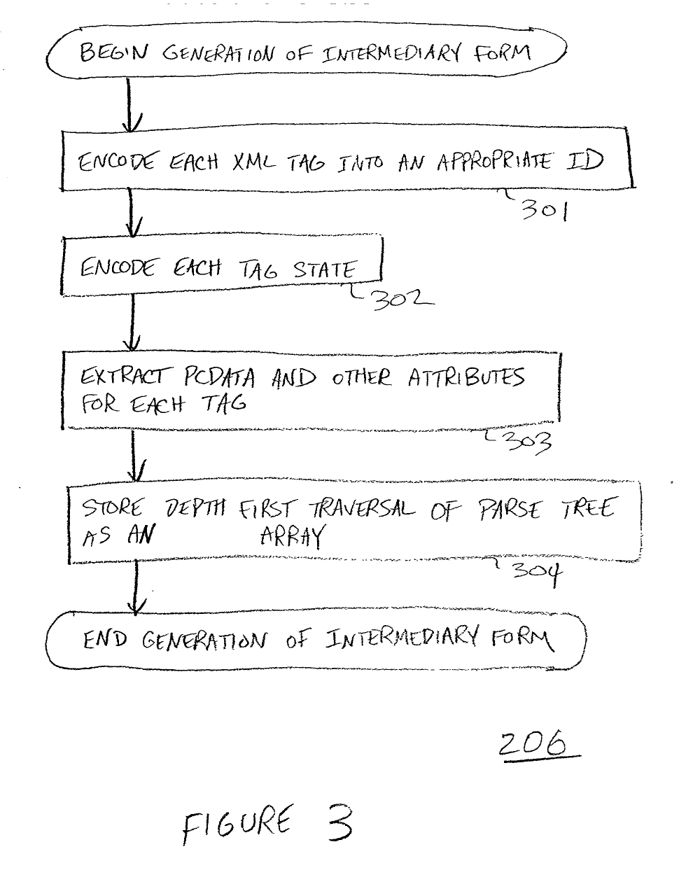

In logic box 205 the Response is received and voice browser 101 parses the document. In an embodiment, the document is parsed using XML parser 406 (FIG. 4) as described below. Once the Response is parsed, it is converted into an intermediary form at logic box 206. FIG. 3 illustrates a method for converting a response into an intermediary form illustrated by logic box 206, according to an embodiment of the present invention. Converting a parsed response into an intermediary form often provides greater efficiency for execution and caching by voice browser 101.

FIG. 3 illustrates a flow chart outlining a method by which voice browser 101 generates an intermediary form of a Response, such as a web page or document, suitable for efficient execution and caching by voice browser 101, according to an embodiment of the present invention.

In logic boxes 301 and 302 the tags of the Response, such as XML tags, are encoded into an appropriate ID and the Tag state (empty, start, end, PCDATA) is also encoded. It will be understood by one skilled in the art that PCDATA refers to character data type defined in XML.

In logic box 303 the PCDATA and attributes for each tag are extracted from the parsed document generating a parsed tree including leaf nodes. In an example, each node in the tree represents a tag. In logic box 304 an overall depth-first traversal of the parsed tree is stored in the form of a linear array. Once the parsed tree is generated and traversed, control is returned to the process 200 (FIG. 2) and the system transfers control to logic box 207.

In logic box 207 the system determines wether the intermediary form of the Request generated in logic box 206 is cacheable. If the intermediate is not cacheable, control is passed to logic box 209 where the system executes the intermediary form of the Request, as described below. If the intermediate is cacheable, control is passed to logic box 208. In logic box 208, the intermediary form is stored in voice browser cache 407. By storing the intermediary form in cache 407 the next time a Request for that document is received, voice browser 101 will not need to retrieve, parse, and process the document into an intermediary form, thereby reducing the amount of time necessary to process and return the requested information.

In logic box 209 the intermediary form of the request which is stored in voice browser cache 407 (FIG. 4) is retrieved and control is passed to logic block 210.

In logic box 210 the stored intermediate form can be viewed and processed by voice browser 101 in order to “execute” and return the content of the document to the user. In an embodiment, execution may include playing a prompt back to the user, requesting a response from a user, collecting a response from a user, producing audio version of text, etc.

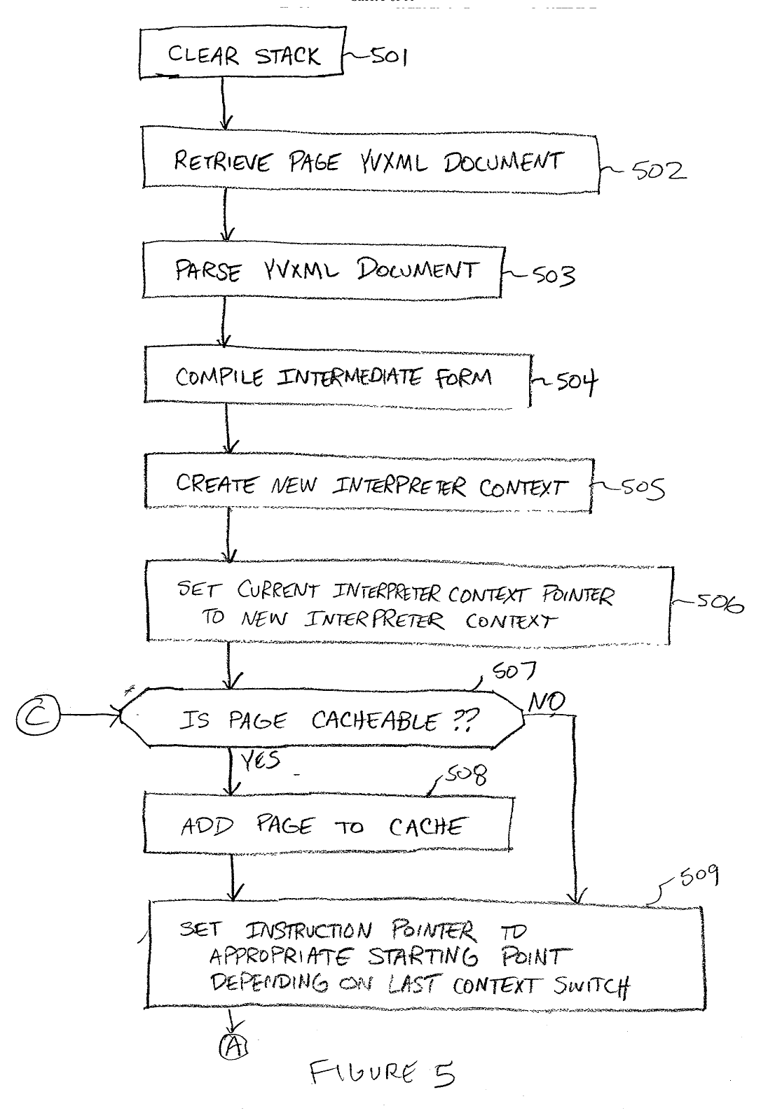

FIG. 4 is an expanded view of voice browser 101 (FIG. 1), according to an embodiment of the invention. For discussion purposes, and ease of explanation, voice browser 101 is divided into the following components or modules: Re-entrant interpreter 401; Compiled Document Source Object 402; Interpreter contexts 403; Application Program Interface object 404; Voice Browser server 405; XML Parser and corresponding interface 406; Document Cache 407; prompt audio 408; Dialog flow 409; and Dynamic Text to Audio Prompt Mapping 410. In an example, the various components of voice browser 101 (including re-entrant interpreter 401) operate on a parsed document pseudo-assembly code, such as yvxml, as illustrated by FIGS. 5-8 and described below.

According to an embodiment of the invention, reentrant interpreter 401 which maintains the separate contents of document which a user may access can operate in Dual-Tone, Multi-Frequency (DTMF) mode, Automatic Speech Recognition (ASR) mode, or a combination of the two. Compiled Document Source Object 402 generates an intermediary form of a document. In an embodiment, Compiled Document Source Object 402 performs the method illustrated as logic box 206 shown in FIG. 2 and shown in greater detail in FIG. 3. The source document is then parsed and compiled into an intermediary form as described above (FIG. 3). The intermediary form includes the following: essentially a depth first traversal of a XML parse tree; Opcodes for each XML tag and start/end/empty/pcdata information in the form of a program, such as assembly level code.

Interpreter contexts 403 of FIG. 4 is created for each page of a requested document. Included in each interpreter context 403 is an Instruction Pointer (IP) 451, a pointer to the compiled “assembly code” for the document 452 (such as a yvxml document), the Universal Resource identifier (URI) of the document 453, dialog and document state information 454, and caching mechanism 455.

One advantage of such an approach is the ability to switch interpreter contexts quickly and efficiently. Within each document, interpretation may involve the dereferencing of labels and variables. This information is already stored in the interpreter context 403 the first time a user accesses a document.

Another advantage is one of state persistence. An example is when a user is browsing a document, chooses an option at a particular point in the document, transitions to the new chosen document, and exits the new document to return to the same state in the previous document. This is achievable with the ability of maintaining separate interpreter contexts for each document the user visits.

API Interface 404 enables the isolation of Text-To-Speech (TTS), ASR, and telephony from voice browser 101. In an embodiment, API 404 may be a Yahoo! Telephony Application Program Interface (YTAP). API 404 may be configured to perform various functions. For example, API 404 may perform the functions of: collect digits, play TTS, play prompt, Enable/Disable bargein, Load ASR Grammar, etc. Collect digits collects inputs in the form of dual-tone multi-frequency input by a user. Play TTS sends text to TTS server 108 and streams the audio back to the user during execution (logic box 210, FIG. 2). Additionally, API 404 may provide the functionality of streaming audio files referenced by URI's or local flies which the user requests. Still further, speech recognition functions, such as dynamic compilation of grammars, loading of precompiled grammars, extracting recognizer results and state are also supported by API 404.

XML Parser 406 is used to parse the documents as described with respect to logic box 205 (FIG. 2). According to an embodiment of the present invention, parser 406 may be any currently available XML parser and may be used to parse documents, such as a yvxml document.

Document Cache 407 allows the caching of compiled documents. When a cached document is retrieved from cache 407, there is no need to parse and generate an intermediate form of the stored document. The cached version of the document is stored in a form that may be readily interpreted by voice browser 101.

FIG. 5 illustrates a method performed by reentrant interpreter 401, compiled document source 402, and parser 406 of voice browser 101 on a requested document, according to an embodiment of the present invention.

The method illustrated in FIG. 5 is initiated by clearing voice browser memory (not shown). In an embodiment, the memory may be in the form of a memory stack. Once the memory is cleared, control is passed to logic box 502 where a document, such as a yvxml document, is retrieved by parser 406 from a separate location, such as the Internet.

In logic box 503 the document is parsed by parser 406 and, in logic box 504, compiled into intermediate form by compiled document source object 402. Once the document has been parsed and compiled, control is passed to logic box 505.

In logic box 505 an Interpreter Context (IC) for the document is created. The IC maintains state information for the requested document. In logic box 506 reentrant interpreter 401 sets a program state “CurrentInterpreterContext” equal to the document's current IC and control is then passed to logic box 507 where it is determined by reentrant interpreter 401 whether the requested document is cacheable. If it is determined that the document is cacheable control is passed to logic box 508 and the document is added to cache 407. If however, it is determined in logic box 507 that the document is not cacheable, control is passed to logic box 509.

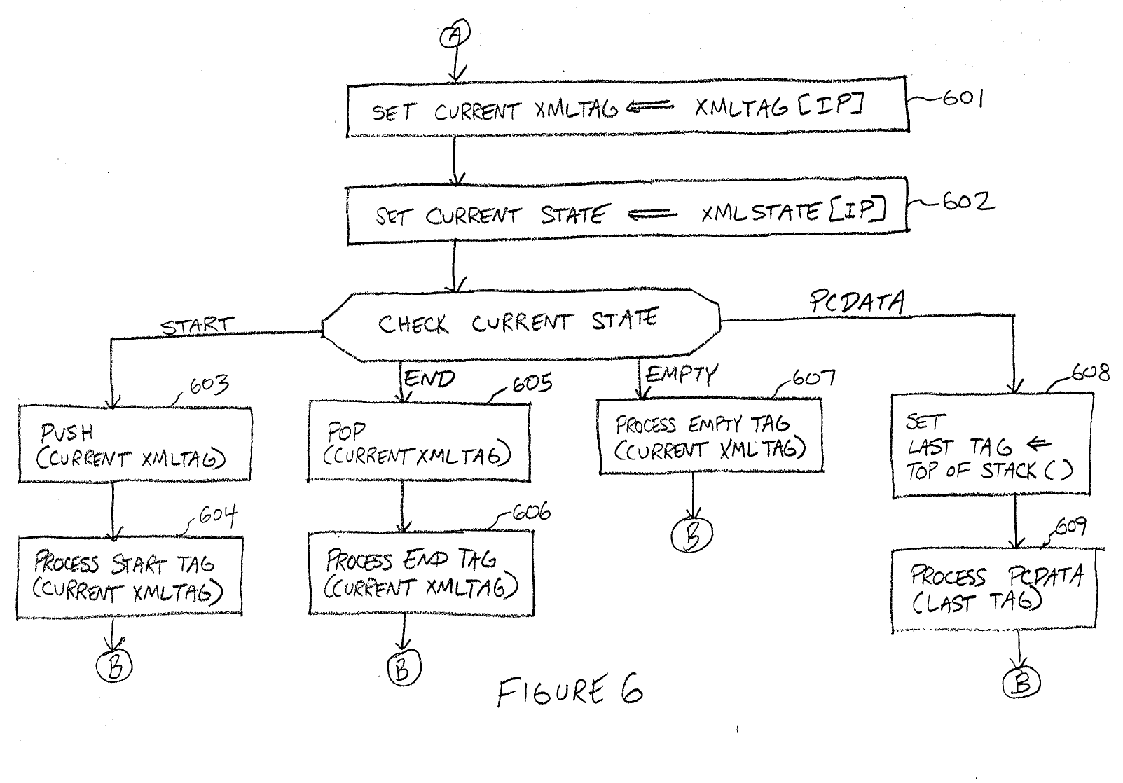

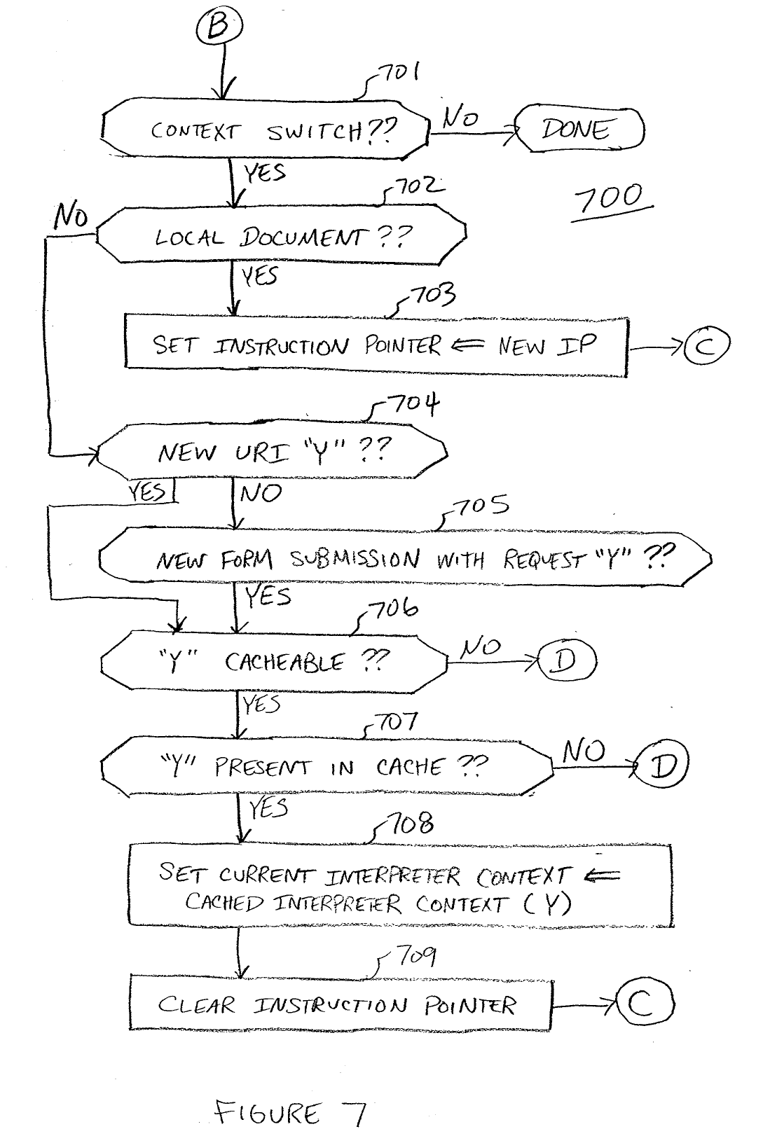

In logic box 509 instruction pointer (IP) 451 is set to an appropriate starting point depending on a last context switch. A context switch as described herein, is a transition from either one document to another, from one location within a document to another location within the same document, a request for different information, or any other request by a user to change there current session status. Context switches are described in greater deal with respect to FIG. 7. Once IP 451 is set in logic box 509, control is passed to logic box 601 of FIG. 6.

FIG. 6 illustrates a method of processing an entry of an array of instructions which constitutes the intermediary form of the web page performed by the reentrant interpreter 401 (FIG. 4) of the voice browser 101, according to an embodiment of the present invention. In an example, the array represents a sequential traversal of the leaf nodes of the parsed tree. In logic box 601, the interpreter 401 sets “CurrentXMLTag =XMLTag[IP]”, and in logic box 602 “CurrentState=XMLState[IP]” is set. The XMLState[IP] may be {START, END, EMPTY, PCDATA}.

If CurrentState=START control is passed to logic box 603. In logic box 603, interpreter 401 executes a Push(CurrentXMLTag) into voice browser 101 memory and at logic box 604 executes ProcessStartTag(CurrentXMLTag). Once interpreter 401 has performed logic boxes 603 and 604, control is passed to logic box 701 (FIG. 7).

If CurrentState=END control is passed to logic box 605 and a Pop(CurrentXMLTag) is performed, and in logic box 606 interpreter 401 executes a ProcessEndTag(CurrentXMLTag). Once interpreter 401 has performed logic boxes 605 and 606, control is passed to logic box 701 (FIG. 7).

If CurrentState=EMPTY control is passed to logic box 607. In logic box 607 interpreter 401 executes a ProcessEmptyTag(CurrentXMLTag). Once interpreter 401 has performed logic box 607, control is passed to logic box 701 (FIG. 7).

If CurrentState=PCDATA control is passed to logic box 608. In logic box 608 interpreter 401 sets LastTag=TopOfStack( ) and in logic box 609 executes a processPCDATA(LastTag). Once interpreter 401 has performed logic boxes 603 and 604, control is passed to logic box 701 (FIG. 7).

FIG. 7 illustrates a method of processing a context switch occurring during the processing of the intermediary form of the document performed by the reentrant interpreter 401 of the voice browser 101, according to an embodiment of the present invention. If the result of the above operations described in FIG. 6 is a switch of context detected by logic box 701, the method performs the following steps, otherwise the process is completed.

In logic box 702 if it is determined that the switch is to another point in the local document control is passed to logic box 703 and interpreter 401 sets IP=newIP, and control is returned to logic box 507 (FIG. 5). If however, it is determined in logic box 702 that the switch is not to another point in the local document control is passed to logic box 704.

In logic box 704 a determination is made as to whether the switch points to a new URI ‘Y’. If it is determined that the switch does point to a new URI ‘Y’ control is passed to logic box 706. Otherwise control is passed to logic box 705 where a determination is made as to whether the switch points to a new form submission with request ‘Y’. In an embodiment, a form submission refers to transition points when the execution of the session changes from one point to another within the same document, or results in the retrieval of another URI. If the determination is affirmative, control is passed to logic box 706. If however the determination is negative the interpreter continues execution of the current session.

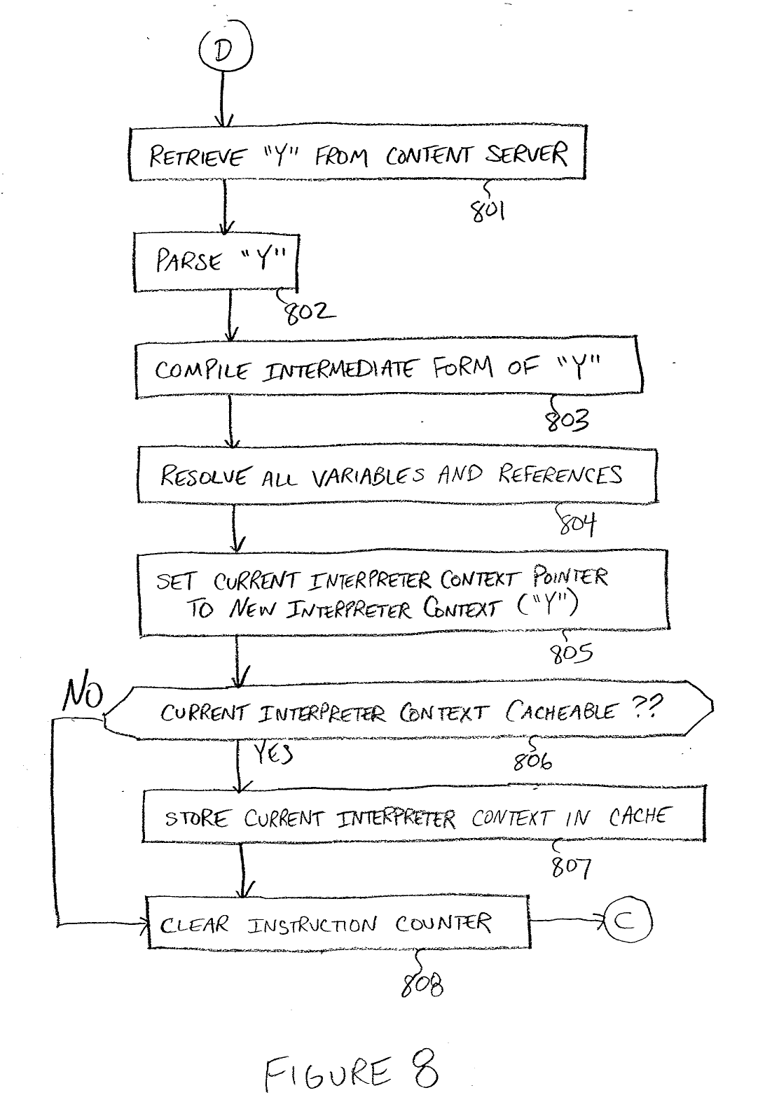

In logic box 706 if ‘Y’ is determined to be cacheable, control is passed to logic box 707, otherwise control is passed to logic box 801 (FIG. 8). In logic box 707 it is determined whether or not ‘Y’ is present in cache. If ‘Y’ is cacheable (logic box 706) and is present in the cache (logic box 707), control is passed to logic box 708. If ‘Y’ is not present in cache, control is passed to logic box 801 (FIG. 8).

In logic box 708 the system sets CurrentInterpreterContext=CachedInterpreterContext(Y) and control is passed to logic box 709 where the IC is cleared (set to 0). Once the IC is cleared the method returns to logic box 507 of FIG. 5.

FIG. 8 illustrates a method performed by reentrant interpreter 401 of voice browser 101 if it is determined that the document requested is either not cacheable or not located in cache, according to an embodiment of the present invention.

In logic box 801 the system retrieves ‘Y’ from backend server 102 and parses ‘Y’ in logic box 802. In logic box 803 ‘Y’ is compiled into an intermediate form and in logic box 804 all variables and references are resolved. At logic box 805 the system sets the CurrentInterpreterContext=NewInterpreterContext(‘Y’).

In logic box 806 a determination is made as to whether ‘Y’ is cacheable. If ‘Y’ is cacheable control is passed to logic box 807 and interpreter 401 stores the CurrentInterpreterContext in cache 407, otherwise control is passed to logic box 808. In logic box 808 the IC is cleared (set to 0). Once the IC has been cleared control is returned to logic box 507 of FIG. 5.

Returning now to FIG. 4, voice browser server 405, which is an expanded view of voice browser 101, may be implemented with a separate server, according to an embodiment of the invention. In an embodiment, whenever a call comes in, and the user chooses to go into a voice browsing session, a Request, such as an HTTP Request, is initiated by voice browser 405. The user is allocated a process for the rest of the voice browsing session. The communication with the telephony module (TAS) and voice browser 405 for this session now switches over to a communication format, such as Yahoo!'s proprietary communication format (“YTAP”). The telephony front end provides voice browser 405 various caller information (as available) such as identification number, user identification (such as a Yahoo! user identification), key pressed to enter the voice browser, device type, etc. Upon completion of the voice browsing session, the process is terminated or pooled to a set of free processes.

Prompt-audio object 408 may be configured to generate prerecorded audio, dynamic audio, text, video and other forms of advertisements during execution (logic box 210, FIG. 2). This allows the system to integrate text-to-speech and audio seamlessly. According to an embodiment of the present invention, the audio types may be, prerecorded audio; dynamic audio; audio advertisements, etc.

The information contained in prompt audio 408 may be organized into categories which are be periodically updated. For example, dynamic audio content for a specific category may be delivered to the system by any transmission means, such as ftp, from any location such as a broadcast station. Thus, an audio clip can then be referenced and rendered by voice browser 405 through API 404.

Pre-recorded audio contained in prompt audio 408 is differentiated from general audio files by audio tags. By prefixing the audio source attribute with a special symbol, the unique ID of the prerecorded audio to be played is specified. Typically, a number of these prerecorded audio are already in memory, and thus can be played efficiently through the appropriate API 404 function call during execution. Utilizing a unique ID for audio allows playing, storing, and organization of prompts more efficiently and reliably.

In the case of dynamic audio (such as daily news which may change periodically and needs to be refreshed) stored in prompt audio 408, there may be a separate audio server (not shown) that keeps track of the latest available audio clip in each category and updates the audio clip for each category with the most current, up-to-date information. Similar to prerecorded audio, dynamic audio content for a specific category may be delivered to the system using any delivery means, such as ftp and may be periodically updated by the delivering party, such as a broadcast audio server.

Audio advertisements located in prompt audio 408 may be tailored to any type of infrastructure. For example, audio advertisements located in prompt audio 408 may be tailored to function with Yahoo!'s advertisement infrastructure. This tailoring is accomplished by providing a tag that specifies various attributes such as location, context, and device information. For example, a tag may include the device type (e.g. “phone”), context information (such as “finance”), the geographics of the caller based on which financial advertisement should be played, etc. This information is submitted to the advertisement server through API 404 which selects an appropriate advertisement for playing.

Interpreter 401 has objects that allow common dialog flow 409 options such as choosing from a list of options (via DTMF or ASR), and submission of forms with field variables. Standard transition commands allow the transition from one document to another (much like normal web browsers). The corresponding state information is also maintained in each interpreter context.

Another component of voice browser 101 is the implementation of the mapping of prompts to prerecorded audio, illustrated as text to audio prompt mapping 410, according to an embodiment of the present invention. The first issue is one of isolation of backend web server 102 from the actual recorded audio prompt list. It is often inefficient for backend server 102 to transform arbitrary text to prerecorded audio based on string matching.

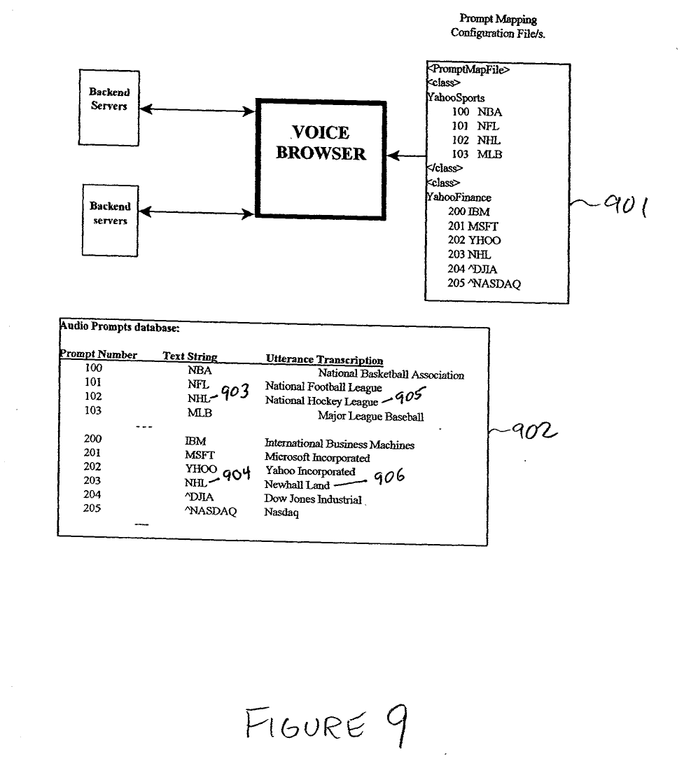

FIG. 9 illustrates the prompt mapping configuration and audio prompt database used by the dynamic typed text to prompt mapping mechanism 410, according to an embodiment of the present invention. Note that in box 902 the text string “NHL” 903 can be rendered using the audio for National Hockey league 905 in a Sports context, while the audio for the company with ticker “NHL” 904 should be rendered to the user if the company name “Newhall Land” 906 has been recorded, and this is in a Finance context. This is illustrated in the Prompt Mapping Configuration File 901 read in conjunction with the Audio Prompts database 902 both shown in FIG. 9.

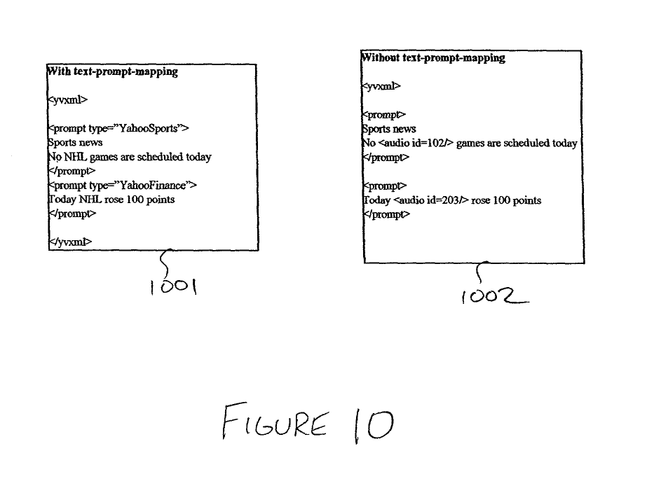

From a backend server 102 point of view, the difference in the content provided to voice browser 101 with and without the dynamic typed text to prompt mapping mechanism 410 can be illustrated as shown in FIG. 10. FIG. 10 illustrates the difference in the content provided to voice browser 101 with the dynamic typed text to prompt mapping mechanism 410 illustrated as box 1001, according to an embodiment of the present invention and without the dynamic typed text to prompt mapping mechanism illustrated as box 1002.

Note that both the examples 1001 and 1002 shown in FIG. 10 may be rendered in the same form. The first problem conventionally noticed without the voice browser prompt-mapping mechanism 410 is the need for all backend servers 102 to know what are all the available audio prompts and the corresponding identifications. The second conventional disadvantage is the inefficiency in mapping that arises out of not utilizing the prompt-class mechanism 410. Lastly, the isolation of the audio prompts from backend servers 102 according to an embodiment of the present invention allows the voice browser 101 to tailor the audio rendering based on user/property/language.

The following section discusses the various advantages of the approach employed by an embodiment of the present invention. In a simple example where text feeds from different sources (e.g. different content providers) is presented to voice browser 101 through a voice portal, it is difficult to keep track of the latest set of audio prompts that are available to voice browser 101 for rendering.

An interesting example for this dynamic prompt mapping of text is stock tickers. When a new company is added, without the dynamic prompt mapping mechanism, all backend servers 102 that provide stock quote/ticker related information should update their code/data with the new entry in order to present the audio clip. With the dynamic prompt mapping mechanism according to an embodiment of the present invention, the voice browser's prompt mapping file(s) (in XML format) need to be updated once, and the effective audio rendering of this new company name is immediately achieved.

The efficiency of the approach, according to an embodiment of the present invention, arises out of the “class-based prompt mapping” mechanism. For instance, the total number of prerecorded prompts can be in the thousands of utterances. It is inefficient to parse each backend text string with all the prompt labels. Thus, each text region that is rendered is assigned a “prompt type/class”. The matching of text to the pre-recorded prompt labels is done only within the specified class. Furthermore the rendering can vary depending on the user or the type. As mentioned in an earlier example, the string NHL can be rendered as “National Hockey League” in the context of a sports category, while the system may need to read the sequence of letters “N H L” as a company name if it is in a finance stock ticker category.

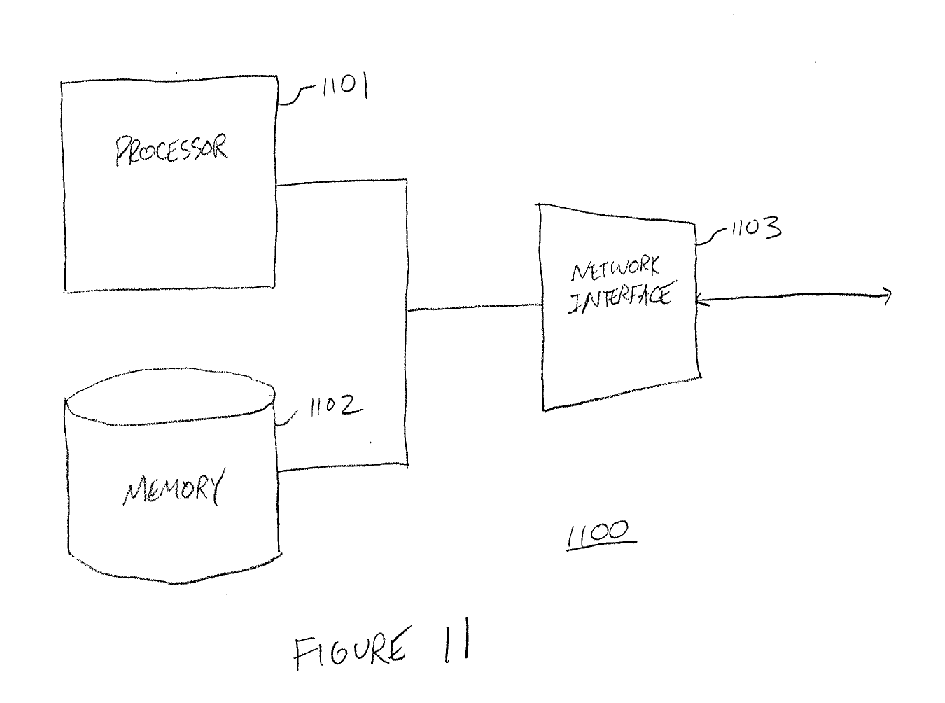

FIG. 11 illustrates a general purpose computer architecture 1100 suitable for implementing the various aspects of voice browser 101 according to an embodiment of the present invention. The general purpose computer 1100 includes at least a processor 1101, one or more memory storage devices 1102, and a network interface 1103.

Although the present invention has been described with respect to its preferred embodiment, that embodiment is offered by way of example, not by way of limitation. It is to be understood that various additions and modifications can be made without departing from the spirit and scope of the present invention. Accordingly, all such additions and modifications are deemed to lie with the spirit and scope of the present invention as set out in the appended claims.

What is claimed is:

1. A method for providing audio access to information through a communication device, comprising the steps of:
receiving an audio request for information;
obtaining the information; and,
executing the obtained information.

2. The method of claim 1 wherein the communication device is a cellular telephone.

3. The method of claim 1 wherein the communication device is a standard telephone.

4. The method of claim 1 wherein the communication device is a personal digital assistant.

5. The method of claim 1 further including the step of:
parsing the information subsequent to obtaining the information.

6. The method of claim 1 further including the step of:
generating an intermediary form of the information.

7. The method of claim 6 wherein the step of generating includes:
encoding an XML tag in the intermediary form; and,
encoding a tag state in the intermediary form.

8. The method of claim 6 wherein the step of generating includes:
generating an array representing the information.

9. The method of claim 1 wherein the information is stored in cache.

10. The method of claim 1 further including the step of:
determining whether the information is stored in a cache; and
wherein the step of obtaining obtains the information from cache.

11. The method of claim 10 wherein information stored in cache is stored in an intermediary form.

12. The method of claim 1 further including the steps of:
parsing the information subsequent to the step of obtaining; and,
generating an intermediary form of the parsed information.

13. The method of claim 1 wherein the step of executing includes:
converting the information into audio;
and playing the audio.

14. The method of claim 1 wherein the step of executing includes:
returning an audio prompt.

15. A method for maintaining interpreter contexts during a voice browsing session, comprising the steps of:
(a) creating a first interpreter context for a first document;
(b) storing the first interpreter context;
(c) receiving a request for a second document;
(d) obtaining the second document; and,
repeating steps (a)-(c).

16. The method of claim 15 wherein the first interpreter context includes:
an instruction pointer;
a program pointer;
a universal Resource Identifier; and,
document state information.

17. The method of claim 15 further including the steps of:
determining whether an interpreter context exists for the second document.

18. A voice browser comprising:
a reentrant interpreter maintaining separate contexts of information;
a parser, parsing the information; and,
a compiled document source object generating an intermediary from of the parsed information.

19. The voice browser of claim 18 including a cache for storing the intermediary form of the information.

20. An apparatus for responding to a Request during a voice browsing session comprising:
a processor;
a processor readable storage medium in communication with the processor, containing processor readable program code for programming the apparatus to:
retrieve a first document responsive to the Request;
create an first interpreter context for the first document, wherein the interpreter context includes a first interpreter context pointer value, a first instruction pointer value, a first state value, and a first tag value;
set a current interpreter context pointer to the first interpreter context value;
set a current instruction pointer to the first instruction pointer value;
set a current state to the first state value; and,
set a current tag to the first tag value.

21. The apparatus of claim 20 further including processor readable program code for programming the apparatus to:
check the current state value;
process the first tag value responsive to the value of the current state value.

22. The apparatus of claim 20 further including processor readable program code for programming the apparatus to:
determine a Request for a second document;
set the current instruction pointer to a second instruction pointer value; and,
determine whether the second document is in cache;
retrieve the second document.

23. The apparatus of claim 22 wherein the second document is not located in cache the apparatus further including processor readable program code for programming the apparatus to:
generate an intermediary form of the second document; and,
execute the intermediary form of the second document.

24. The apparatus of claim 23 further including processor readable program code for programming the apparatus to:
store the intermediary form of the second document in cache.

25. The apparatus of claim 23 wherein execution includes playing audio representing the second document.

26. An apparatus for generating an audio response during a voice browsing session, comprising:
a voice browser; and,
a prompt audio object generating audio in response to a request.

27. The apparatus of claim 26 wherein the prompt audio object stores a at least one prerecorded audio information.

28. The apparatus of claim 27 wherein the prerecorded audio information is periodically updated.

29. The apparatus of claim 26 wherein the prerecorded audio information includes tags identifying the information to the voice browser.

30. The apparatus of claim 29 wherein the tag includes: location information, context information, and device information.

31. A system for mapping prompts to prerecorded audio, comprising:
an audio prompt database storing at least one prerecorded audio;
code for generating a file identifying the least one prerecorded audio, wherein the file identifies the prerecorded audio using a unique identification; and,
code for organizing the prerecorded audio file into contexts.
